(19) United States
(12) Patent Application Publication
(10) Pub. No.: US 2012/0095659 A1
(43) Pub. Date: Apr. 19, 2012

(54) Automatic Control of Driveline States

(75) Inventors: Ashok E. Rodrigues, Farmington Hills, MI (US); Andreas E. Perakes, Canton, MI (US); Richard D. Bruns, Dearborn, MI (US); Jim Koppenol, De Lier (NL); Derek K. Ward, Duisburg (DE); Nicholas E. McCubbin, Farmington Hills, MI (US); Peter J. Grutter, Plymouth, MI (US)

(73) Assignee: FORD GLOBAL TECHNOLOGIES, LLC, Dearborn, MI (US)

(21) Appl. No.: 12/906,388

(22) Filed: Oct. 18, 2010

(51) Int. Cl. B60K 28/16

(52) U.S. Cl. 701/69

(57) ABSTRACT

A method for controlling a vehicle driveline includes using current conditions to estimate wheel slip probability and vehicle dynamics handling support requirements, producing two-wheel drive operation, if said slip probability and handling support requirement is low and a condition for forced driveline connection is absent, and producing four-wheel drive operation, if said slip probability and/or handling support requirement is high and a condition for forced driveline disconnection is absent.

### BACKGROUND OF THE INVENTION

1. Field of the Invention

This invention relates generally to a motor vehicle driveline, which in operation transmits power continually to a first wheel set and selectively to a second wheel set.

2. Description of the Prior Art

All-wheel-drive (AWD) systems tend to reduce vehicle fuel economy due to increased driveline parasitic losses, even when AWD is not activated. Driveline disconnect systems improve fuel economy by disconnecting as many of the driveline rotating parts as possible, as close to the transmission output and the secondary drive wheels as possible, when all-wheel-drive is not activated.

In virtually all front-wheel-drive (FWD) vehicles and many rear-wheel-drive (RWD) vehicles that produce all-wheel drive (AWD) or four-wheel drive (4WD), operation in two-wheel-drive (2WD) is not provided. In such vehicles, 2WD operation is produced in response to being manually selected by the vehicle operator. But requirement that 2WD operation be manually selected creates an inconvenience for operators, who may expect fully automatic operation of the driveline. It also decreases fuel economy for operators who leave the vehicle in AWD/4WD mode, or in vehicles that provide no selectable 2WD operation.

A need exists in the industry for a control method that automatically switches between 2WD and AWD or 4WD modes to save fuel while minimizing or eliminating any disruptions that the vehicle occupants might notice.

### SUMMARY OF THE INVENTION

A method for controlling a vehicle driveline includes using current conditions to estimate wheel slip probability and the likelihood that AWD torque transfer will be required to support vehicle handling performance, producing two-wheel drive operation, if said slip probability is low, handling support is not required and a condition for forced driveline connection is absent, and producing four-wheel drive operation, if said slip probability is high and/or handling support is required and a condition for forced driveline disconnection is absent.

The control provides a method for automatically switching between 2WD and AWD/4WD modes to improve fuel economy while minimizing or eliminating any disruptions that the vehicle occupants might notice.

The control monitors numerous vehicle signals and preemptively produces shifts from 2WD to AWD/4WD when wheels slip is likely to occur and/or handling support is required. The control uses a rule based or fuzzy logic control system to anticipate the likely occurrence of wheel slip, and performs the shift at a connect speed that is determined to not produce excessive noise, vibration or harshness.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a schematic diagram of a motor vehicle driveline having primary and secondary road wheels;

FIG. 2 is a cross section showing a drive system that connects a power source continually to a primary wheel set and selectively to a secondary wheel set; and

FIG. 3 is diagram showing information flow and method steps for engaging the driveline of FIG. 1.

### DESCRIPTION OF THE PREFERRED EMBODIMENT

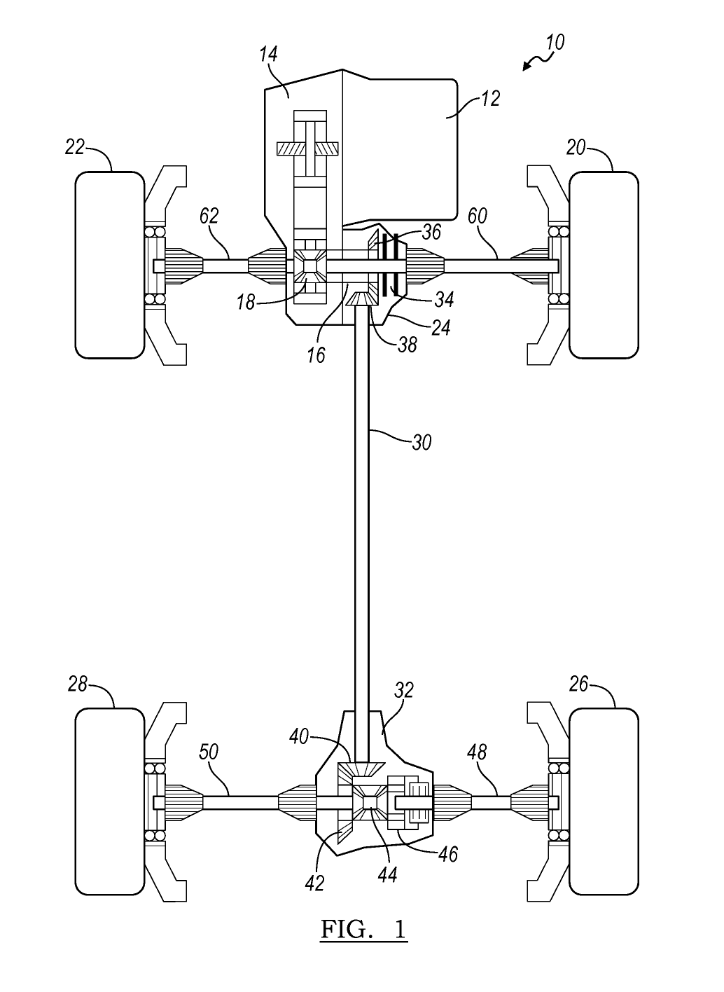

The driveline 10 of FIG. 1 includes a power source 12, such as an internal combustion engine or an electric motor, and a transmission 14 that produces a variable ratio between the speed of its output 16, which is continually driveably connected through a differential mechanism 18 to the primary road wheels 20, 22, and the speed of the transmission input, which is driveably connected to the power source.

The primary wheels 20, 22 are driven continually by the engine during torque transfer conditions. The secondary wheels 26, 28 are undriven road wheels, except that they are driven by the engine during torque transfer conditions when AWD is operating.

A power transfer unit (PTU) 24 transmits power from the transmission output 16 selectively to the secondary road wheels 26, 28. A driveshaft 30 transmits rotating power from the PTU 24 to a rear drive unit (RDU) 32.

The PTU 24 comprises a coupler 34, such as a dog clutch or synchronizer, whose input is driveably connected to the transmission output 16; a bevel ring gear 36 connected to the output of the PTU coupler 34, and a bevel pinion gear 38 meshing with the bevel ring gear 36 and connected to driveshaft 30. The PTU coupler 34 disconnects the rotating components of the PTU and driveline components downstream of the PTU from the transmission output 16.

The RDU 32 includes a bevel pinion gear 40, secured to driveshaft 30; a bevel ring gear 42, meshing with pinion 40, a differential mechanism 44, and a low-drag coupling 46. The secondary wheels 26, 28 are driven by halfshafts 48, 50 though coupling 46 and differential 44. Coupling 46 alternately connects and disconnects halfshafts 48, 50 from the rotatable components of the RDU 32.

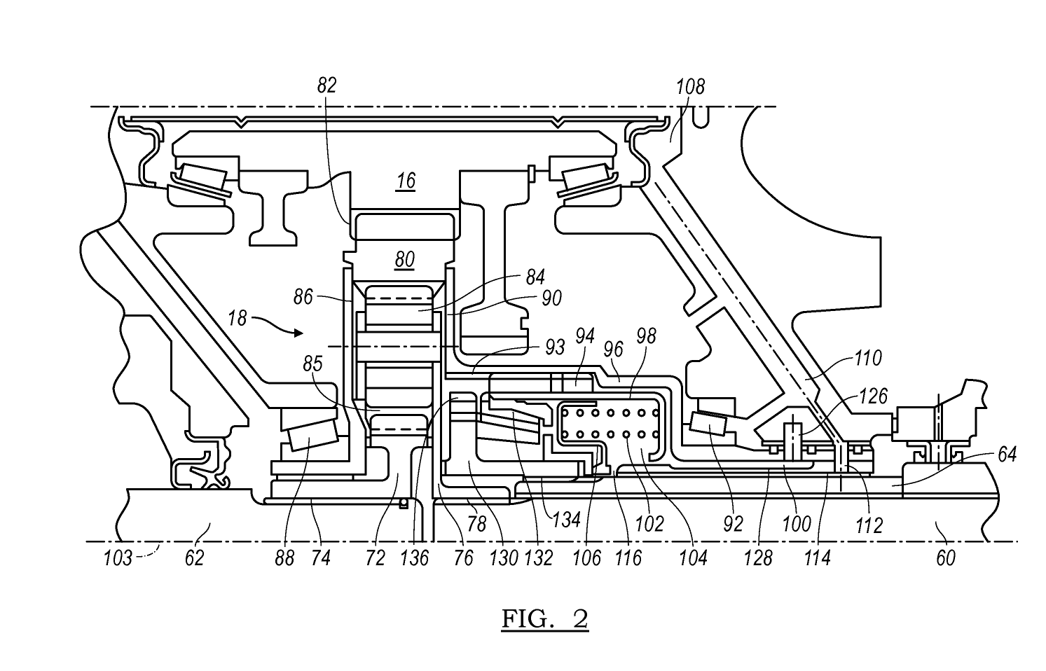

FIG. 2 illustrates details of the power path that connects the transmission output 16 continually to the halfshafts 60, 62 for the primary wheels 20, 22 through differential 18, and to the PTU input shaft 64, which is connected to bevel ring gear 36.

A compound planetary differential 18 includes a sun gear 72, secured through a spline 74 to axle shaft 62; a carrier 76, secured through a spline 78 to axle shaft 60; a ring gear 80, engaged with an pinion 82 formed on the transmission output shaft 16; first planet pinions 84 supported on the carrier and meshing with the ring gear 80; and second planet pinions 85 supported on the carrier 76 and meshing with the sun gear 72 and the first planet pinions 84. One side of ring gear 80 is secured to a disc 86 and supported at a bearing 88; the other side of ring gear 80 is secured to a disc 90 and supported at a bearing 92. Disc 90 is formed with an internal spline 93, which engages an external spline formed on a coupler sleeve 94.

Disc 90 forms a cylinder 96, which contains a piston 98, actuated by pressurized hydraulic fluid carried to cylinder 96 through a passage 100. A compression return spring 102 restores piston 98 to the disengaged position shown in the FIG. 2. Piston 98 is secured to coupler sleeve 94 such that they move along an axis 103 and rotate about the axis as a unit.

The volume 104 enclosed by piston 98 and spring retainer 106 forms a balance dam containing hydraulic fluid supplied from source of hydraulic lubricant 108 through a lube circuit, which includes passages 110, 112, 114, 116.

In operation, fluid from a source of line pressure is carried to a valve, which is controlled by a variable force solenoid. The valve opens and closes a connection between the line pressure source and passages 126, 128, which carry piston-actuating pressure to cylinder 96 depending on the state of the solenoid. When passages 126 and 128 are pressurized, piston 98 and coupler sleeve 94 30 move leftward, causing frictional contact at the conical surface between a member 130 and a synchronizing ring 132. Member 130 is rotatably secured by spline 134 to PTU input shaft 64. As the speed of member 130 is synchronized with the speed of ring gear 80, the internal spline of coupler sleeve 94 engages the dog teeth on synchronizing ring 132 and the clutch teeth 136 on the radial outer surface of connecting member 130, thereby driveably connecting ring gear 80 and PTU input shaft 64.

When passages 126 and 128 are vented, piston 98 and sleeve 94 move rightward to their disengaged positions, causing connecting member 130 to disengage the ring gear 80, thereby disconnecting ring gear 80 from PTU input shaft 64.

Although the description refers to the speed of connecting member 130 being synchronized with the speed of ring gear 80 using a synchronizer, a connection between ring gear 80 and PTU input shaft 64 can be completed using a coupler, such as a clutch, instead of a synchronizer.

In the disconnected state, the RDU coupling 46 and PTU coupling 34 are open, causing the rotatable RDU components, driveshaft 30, and rotatable PTU components to be disconnected from the secondary wheels 26, 28 and halfshafts 48, 50.

In the connected state, the PTU coupler 34 is closed, causing driveshaft 30 to rotate with the primary wheels 20, 22 and transmission output 16. The RDU coupling 46 has a variable torque transmitting capacity, which may produce a fully engaged connection or a defined speed difference between driveshaft 30 and the secondary wheels 26, 28, as required to produce AWD operation.

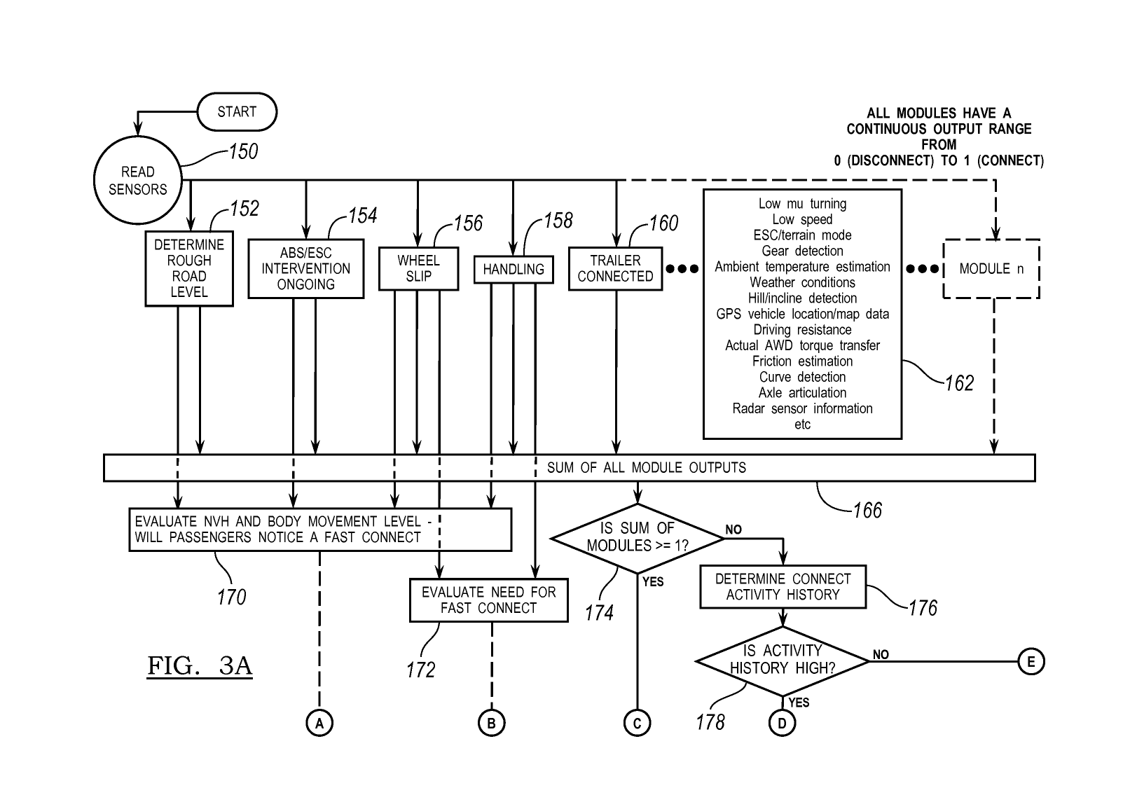

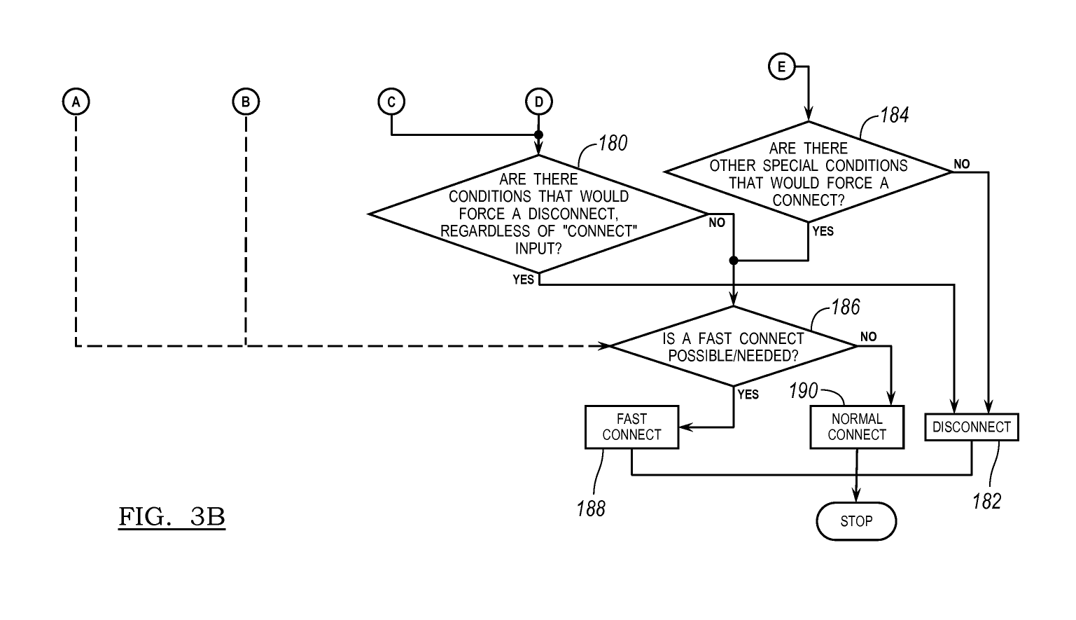

FIG. 3 shows the method steps of a rule-based or fuzzy logic type control system for engaging and disengaging 2WD, and AWD/4WD in the driveline of FIG. 1. The probability of vehicle wheel slip occurring or handling support being required under current conditions is estimated with reference to the current vehicle, road and weather conditions, which may include without limitation, vehicle operator driving patterns evidenced by driver control of the vehicle, terrain detection, terrain response mode, temperature, GPS data, weather data, coefficient of friction detection methods such as comparing amount of tire rotation for driven vs. undriven wheels, difference in left-to-right tire rotation during turns vs. steering wheel angle, and actual yaw vs. intended yaw.

At step 150 a controller reads various driveline sensors incorporated in software modules. The output for each module is in a range between 0 and 1, zero representing a low probability that wheel slip will occur due to the sensed variable corresponding to a respective module, unity representing a high probability that wheel slip will occur due to the current value of the sensed variable. For example, certain sensors indicate the degree to which the following current conditions indicating that wheel slip is probable or imminent and/or that handling support is required: (i) the vehicle is travelling on a rough road 152, (ii) anti-lock brake system (ABS), brake traction control system (BTCS) or electronics stability control (ESC) intervention is currently active 154; (iii) wheel slip is occurring 156; (iv) vehicle handling is challenging 158; and (v) the vehicle is towing a trailer 160. Other output signals 162 produced by vehicle sensors indicate the degree to which the following variables influence wheel slip and the weight attributed to the current value of the variable: the vehicle is turning on a road having a low coefficient of friction; vehicle speed is low; the status of BTCS/ESC over-ride switch, the status of the AWD terrain mode selector switch; detected gear in which the transmission is operating; estimated ambient temperature; weather conditions (either sensed directly or inferred from an external wireless data transmission such as a weather report); hill or incline detected; GPS vehicle location data; driving resistance; AWD torque transfer; estimation of tire to road friction; road curve detected; axle articulation (either measured directly via sensors located on the vehicle or inferred from calculation of various vehicle state conditions); radar sensor information. In this way a weighted sum is produced indicating the probability that wheel slip will occur under current conditions.

“Terrain Mode” is the operating mode selected in a Terrain Management system. Different modes can be selected by the driver for different driving situations, e.g. Normal, Grass/Gravel/Snow, Mud/Ruts, Sand. Terrain Mode is independent of ESC, but can change ESC modes. Axle articulation is the movement of the suspension. When driving off-road, for example, the wheels might go from being at full droop, i.e., fully extended, to being at full compression. We look at all four wheels. Wheel travel sensors, fitted to all four wheels with active damping, would be used to measure wheel position, and it would be tracked over time to assess the road/ground conditions.

A controller monitors these signals and changes preemptively the operating state of the driveline 10 between 2WD and AWD/4WD in accordance with the weighted sum.

At step 166 the sum of the module outputs is determined.

At step 170, signals 152, 154, 156, 158 are used to evaluate noise, vibration and harshness (NVH) and vehicle body movement to determine whether the vehicle occupants will notice a fast engagement of AWD/4WD. Reconnecting the AWD system too quickly can result in audible clunks, tactile vibrations, or a drop in vehicle acceleration that can be felt or heard by vehicle occupants as objectionable NVH. This step recognizes that various NVH events, such as driving on a rough road, will mask what would normally be perceivable NVH resulting from the rapid engagement of the AWD system on a smooth road, thereby allowing a much faster engagement time than would normally be considered acceptable.

At step 172, signals 156, 158 are used to evaluate need for a fast engagement of AWD/4WD. The need for a fast engagement may result from the need for AWD to immediately reduce wheel slip or influence vehicle handling to maintain acceptable vehicle driveability.

At step 174 a test is made to determine whether the sum determined at step 166 is equal to or greater than a reference, such as 1.0.

If the result of test 174 is logically false, at step 176, the controller determines the history of changes in driveline state between 2WD and AWD/4WD.

At step 178 a test is made to determine whether changes in driveline state between 2WD and AWD/4WD have occurred at a high rate, e.g., a rate that exceed a reference rate.

If the result of test 178 is true indicating frequent changes in driveline state, or if test 174 is true indicating a high probability of wheel slip and/or that handling support is required, control advances to step 180 where the controller determines whether a condition is present that would require a disconnect regardless of connect input, i.e., require that the driveline produce 2WD. Conditions that would require a disconnect regardless of connect input may include an ESC event in progress, a reported failure mode, and the current gear produced by the transmission 14.

If the result of test 178 is false, at step 184 the controller determines whether there are special conditions that would force a connect, i.e., require that the driveline produce AWD/4WD. Conditions that would require a connect regardless of disconnect input may include a driver disabled ESC system or has selected a special Terrain Response mode, very low vehicle speed or a reported failure mode.

If the result of test 180 is true, or the result of test 184 is false, at step 182 the controller disconnects the transmission output 16 from the RDU 32, thereby producing 2WD.

If the result of test 180 is false indicating that a disconnect would not be forced, or test 184 is true indicating that a connect would be forced, at step 186, a test is made to determine whether a fast connect is possible or required.

If the result of test 186 is true, at step 188 a fast connection is executed by connecting transmission output 16 through PTU input shaft 64 and bevel ring gear 36 to the RDU 32, thereby producing AWD/4WD.

If the result of test 186 is false, at step 190 a connection between the transmission output 16 and the RDU 32 is executed at normal speed, thereby producing AWD/4WD.

The speed of connection can be continuously variable depending on current conditions as represented by the outputs signals of the sensors. For example, during a “normal connect,” the AWD system can be connected with “good NVH” in a much shorter time at lower speeds than if the vehicle is traveling at higher speeds. Similarly, at higher operating temperatures a “normal connect” can occur much quicker than at lower temperatures. A fast connect would be around 100 ms, and a slow connect about 400ms.

If preemptive measures of FIG. 3 fail, traction control and/or stability control would be used to maintain acceptable vehicle performance during the first AWD/4WD engagement.

Powertrain controls can be used to increase torque during each 2WD to AWD/4WD shift to compensate for the loss of power due to inertia and spin resistance of the secondary drive path.

The driveline system will disconnect, i.e., shift from AWD/4WD to 2WD, using similar inputs, potentially including ignition cycles and cruise control status.

In a FWD-based application, a low loss clutch with limited capacity can be placed in front of the PTU 24 to synchronize the PTU, rear driveshaft 30 and front end of the AWD clutch under many conditions while assistance will be required from the AWD clutch will be required under more severe conditions such as operating at high vehicle speed or low temperature. Alternately, if vehicle packaging permits, a high capacity clutch may be placed in front of the PTU to synchronize the secondary driveline under all conditions while a simple dog clutch is utilized to lock and unlock the secondary driveline from the rear wheels.

In accordance with the provisions of the patent statutes, the preferred embodiment has been described. However, it should be noted that the alternate embodiments can be practiced otherwise than as specifically illustrated and described.

The invention claimed is:

1. A method for controlling a vehicle driveline, comprising:
(a) using current conditions to estimate wheel slip probability;
(b) producing two-wheel drive operation, if said slip probability is low and a condition for forced driveline connection is absent;
(c) producing four-wheel drive operation, if said slip probability is high and a condition for forced driveline disconnection is absent.

2. The method of claim 1, wherein steps (a) and (b) further comprise:
determining a weighted sum of vehicle, road and atmospheric conditions; and
determining that said sum is less than a reference.

3. The method of claim 1, wherein step (b) further comprises:
producing two-wheel drive operation, if said slip probability is high and a condition requiring forced disconnection is present.

4. The method of claim 1, wherein step (b) further comprises:
producing two-wheel drive operation, if a rate of driveline connection is low.

5. The method of claim 1, wherein step (c) further comprises:
producing four-wheel drive operation at normal speed, if a condition requiring fast connection is absent.

6. The method of claim 1, wherein step (c) further comprises:
producing four-wheel drive operation at fast speed, if a condition requiring fast connection is present.

7. The method of claim 1, wherein steps (a) and (c) further comprise:
determining a weighted sum of occurrence of vehicle, road and atmospheric conditions;
determining that said sum is greater than a reference.

8. A method for controlling a vehicle driveline, comprising:
(a) using current conditions to estimate wheel slip probability;
(b) producing two-wheel drive operation, if said slip probability is low and a condition for forced driveline connection is absent;
(c) producing four-wheel drive operation, if a condition for forced driveline disconnection is absent, and one of said slip probability is high and a rate of driveline connection is high.

9. The method of claim 8, wherein steps (a) and (b) further comprise:
determining a weighted sum of vehicle, road and atmospheric conditions; and
determining that said sum is less than a reference.

10. The method of claim 8, wherein step (b) further comprises:
producing two-wheel drive operation, if said slip probability is high and a condition requiring forced disconnection is present.

11. The method of claim 8, wherein step (b) further comprises:
producing two-wheel drive operation, if a rate of driveline connection is low.

12. The method of claim 8, wherein step (c) further comprises:
producing four-wheel drive operation at normal speed, if a condition requiring fast connection is absent.

13. The method of claim 8, wherein step (c) further comprises:
producing four-wheel drive operation at fast speed, if a condition requiring fast connection is present.

14. The method of claim 8, wherein steps (a) and (c) further comprise:
determining a weighted sum of occurrence of vehicle, road and atmospheric conditions;
determining that said sum is greater than a reference.

15. A method for controlling a vehicle driveline, comprising:
(a) using current conditions to estimate wheel slip probability and need for vehicle dynamics handling support;
(b) producing two-wheel drive operation, if said slip probability and handling support requirement are low and a condition for forced driveline connection is absent;
(c) producing four-wheel drive operation, if said slip probability is high, handling support is required, and a condition for forced driveline disconnection is absent.

16. The method of claim 15, wherein steps (a) and (b) further comprise:
determining a weighted sum of vehicle, road and atmospheric conditions; and
determining that said sum is less than a reference.

17. The method of claim 15, wherein step (b) further comprises:
producing two-wheel drive operation, if said slip probability and/or vehicle dynamics handling support requirement is high and a condition requiring forced disconnection is present.

18. A method for controlling a vehicle driveline, comprising:
(a) using current conditions to estimate wheel slip probability and need for vehicle dynamics handling support;
(b) producing two-wheel drive operation, if said slip probability and the handling support requirement are low, and a condition for forced driveline connection is absent;
(c) producing four-wheel drive operation, if a condition for forced driveline disconnection is absent, and one of said slip probability is high, the handling support requirement is high, and a rate of driveline connection is high.

19. The method of claim 8, wherein steps (a) and (b) further comprise:
determining a weighted sum of vehicle, road and atmospheric conditions; and
determining that said sum is less than a reference.

20. The method of claim 8, wherein step (b) further comprises:
producing two-wheel drive operation, if said slip probability is high, the handling support requirement is high, and a condition requiring forced disconnection is present.
